(19) United States
(12) Patent Application Publication
(10) Pub. No.: US 2023/0052856 A1
(43) Pub. Date: Feb. 16, 2023

(54) Electric Vehicle with Electromagnetic Induction Power Generating Device

(71) Applicant: Richard Shao Wei Chin, Taipei (TW)

(72) Inventor: Yueh-Feng Chiang, Taipei (TW)

(21) Appl. No.: 17/400,103

(22) Filed: Aug. 11, 2021

(51) Int. Cl. H02J 7/14; H02J 50/10; H02J 50/90; H02J 7/00; B60L 50/60; H02K 7/18; H02K 1/14; H02K 3/18; H02K 1/27

(52) U.S. Cl. CPC H02J 7/143; H02J 50/10; H02J 50/90; H02J 7/0013; B60L 50/60; H02K 7/1823; H02K 1/14; H02K 3/18; H02K 1/27

(57) ABSTRACT

An electric vehicle with magnetic induction power generating device includes an vehicle body, at least one battery pack installed inside the vehicle body, at least one power generation device electrically coupled to the at least one battery pack for providing electricity, a transmission device placed between the battery pack and the power generating device, and at least one motor for driving the electric vehicle, wherein the at least one power generating device can be coupled to at least one free-running wheel of the vehicle for converting a rotating energy of the at least one free-running wheel into electricity.

### BACKGROUND

### 1. Technical Field

The present invention relates to a power generating device, and more particularly, relates to an electric vehicle with electromagnetic induction generating device.

### 2. Related Arts

At present, the conventional electric vehicle is driven by the electric energy provided by the on-board battery (single energy source). Since the capacity of the battery is limited, there will inevitably be an issue that the battery energy is exhausted and the electric vehicle will not run, which will cause the driver to be trapped on the road. As for the hybrid electric vehicle, because it retains the mechanical transmission system and the fuel engine, its system efficiency is low, which is unfavorable to the trend of energy saving, emission reduction, and low-carbon economy.

Among them, the above-mentioned vehicles are driven only by electricity. One possible disadvantage of this type of known or commercially available engine (motor) is frequent charging requirements, which must be fulfilled by domestic or commercial charging stations. This kind of pure electric vehicle has the additional disadvantage of having a short and impractical driving range before it needs to be charged.

Therefore, in the field of electric vehicles, especially in the field of power generation and/or improved transmission system, there is a need to extend the operable travel distance of vehicles driven only or partly by electricity, including hybrid vehicles using power converter components. The power converter assembly proposed to solve the above-mentioned problems should utilize the basic energy provided by the continuous rotation of the vehicle's non-driving wheels, and the supplementary current provided in this way is sufficient to maintain sufficient and operable charges on the installed battery components associated with electric vehicles. In addition, the energy converter assembly proposed in this preferred embodiment should be able to convert the mechanical energy generated by the rotation of the vehicle's non-driving wheels into sufficient auxiliary electric current, which can not only maintain the charge on the battery power supply associated with this type of vehicle, but also independently or appropriately powers the vehicle and/or auxiliary electronic components (such as personal electronic equipment) commonly used with the vehicle.

Since its invention, the generator has been playing the core device of electricity generation, and its main function is to convert mechanical energy into electrical energy. Mechanical energy can come from internal combustion engines, turbofans, compressed air, etc., or mechanical energy from other sources. In practical applications, generators provide almost all of the electric power for power grids. Therefore, based on factors such as environmental protection and environmental sustainability, how to improve power generation efficiency is an important issue.

The motor converts electrical energy into mechanical energy by reverse operation, and there are many similarities between the motor and the generator.

Generators and motors (such as AC induction or DC permanent magnet motors) generally include an external stator or fixed component, which is usually hollow cylindrical and includes wire coils arranged on the inner sidewalls thereof. For motor applications, current flows into a plurality of pairs of coils arranged in the stator (three-phase motor usually contains three pairs of separate coils, which are arranged in a manner that is opposite and partially offset along the circumferential direction), causing the internally positioned rotor assembly to rotate.

The rotor is usually a solid cylinder fixed inside the stator (with a definite air gap between the outer cylindrical surface of the rotor and the inner surface of the stator), and its outer shaft extends outward from the axial centerline of the rotor.

Existing electric motors or generators contain components with iron sheets, such as laminated steel sheets or silicon steel sheets, which are used as the stator coil winding cores. The magnetic field generated by these components can interact with the permanent iron on the rotor to reduce power generation efficiency.

Based on the aforementioned disadvantages of insufficient endurance of pure electric vehicles before they need to be recharged, a high-efficiency energy converter assembly, that is, an electromagnetic induction power generation device that can be integrated in electric vehicles, can especially be integrated in the free-running wheels of the vehicle. It is necessary to convert the mechanical energy generated by free-running wheels of the vehicle into sufficient auxiliary electric current to charge the battery pack installed in the electric vehicle.

### SUMMARY

In order to solve the above drawbacks of the insufficient endurance of pure electric vehicles, a high-efficiency power converter assembly is required to convert the mechanical energy generated by the rotation of the vehicle's free-running wheels into sufficient auxiliary electric current. The present invention provides an electric vehicle capable of integrating a high-efficiency electromagnetic induction power generation device.

A high-efficiency and iron-loss-free generator can be realized by arranging the coil windings using only copper wires into suitable coil winding stacks and integrating them into a rotor assembled with permanent magnets.

Based on the above objective, the present invention proposes an electric vehicle with an electromagnetic induction power generation device, which includes an vehicle body, at least one battery pack installed inside the vehicle body, at least one power generation device electrically coupled to the at least one battery pack for providing electricity, a transmission device placed between the battery pack and the power generating device, and at least one motor for driving the electric vehicle, wherein the at least one power generating device can be coupled to at least one free-running wheel of the vehicle for converting a rotating energy of the at least one free-running wheel into electricity.

In one preferred embodiment, the at least one power generating device includes a cylindrical shell, a stator assembly having a plurality stator units axially and equal spaced fixed inside the cylindrical shell, each stator unit including a stator base and a plurality of coils azimuthally arranged within the stator base with equal radical angle distribution, and a rotor assembly having a plurality of rotor units, each rotor unit including a rotor base and a plurality of permanent magnets azimuthally arranged inside the rotor base with equal radical angle distribution, wherein the plurality of rotor units are connected by a rotation shaft for rotating coherently and each rotor unit is arranged in between neighboring stator units.

In one preferred embodiment, the stator base is a cylindered shape having a center hole for passing the rotation shaft.

In one preferred embodiment, the stator base has a space formed between a circular inner wall and a circular outer wall for accommodating the coils.

In one preferred embodiment, the space formed between the circular inner wall and the circular outer wall of the stator base is equally partitioned into two subsections along its axial direction.

In one preferred embodiment, the coils installed inside both of the subsections of the stator base.

In one preferred embodiment, each of the coils is winded by enamel-insulated conducting wire and forms a loop structure with bended “Z” shape cross section.

In one preferred embodiment, each of the coils is partially stacked on top of each other side by side for forming compact packing.

In one preferred embodiment, the stator base is non-magnetic.

In one preferred embodiment, the rotor unit includes a non-magnetic cylindered rotor base having a center hole for coupling the rotation shaft.

In one preferred embodiment, magnetic poles of neighboring permanent magnets have opposite magnetic polarity arranged alternatively.

In one preferred embodiment, each of the permanent magnets is a columnar with equilateral triangular cross section and the permanent magnets are arranged to have their individual bisector aligned with a set of radical axes of the rotor base with equal radical angle distribution.

In one preferred embodiment, base of the permanent magnets with a first type of the magnetic polarity are configured to face toward center of the rotor base while the base of permanent magnets with a second type of the magnetic polarity are configured to face toward outer edge of the rotor base.

In one preferred embodiment, the second type the magnetic polarity is N polarity.

In one preferred embodiment, the second type the magnetic polarity is S polarity.

In one preferred embodiment, each of the permanent magnets is a NdFeB magnet

### BRIEF DESCRIPTION OF THE DRAWINGS

The components, characteristics and advantages of the present invention may be understood by the detailed descriptions of the preferred embodiments outlined in the specification and the drawings attached:

FIG. 1 illustrates a block diagram of an electric vehicle with an electromagnetic induction power generation device according to a preferred embodiment of the present invention.

FIG. 2 illustrates a three-dimensional schematic diagram of an electromagnetic induction power generation device for electric vehicles according to a preferred embodiment of the invention.

FIG. 3 illustrates a cross-sectional schematic diagram of an electromagnetic induction power generation device for electric vehicles according to a preferred embodiment of the present invention.

FIG. 4(a) illustrates a front view of an electromagnetic induction power generation device for electric vehicles according to a preferred embodiment of the present invention.

FIG. 4(b) illustrates a cross-sectional schematic diagram of the electromagnetic induction power generation device for electric vehicles according to a preferred embodiment of the present invention along the E-E cutting direction according to a preferred embodiment of the present invention.

FIG. 4(c) illustrates a cross-sectional schematic diagram of the electromagnetic induction power generation device for electric vehicles according to a preferred embodiment of the present invention along the F-F cutting direction according to a preferred embodiment of the present invention

FIG. 5(a) illustrates a front view of a rotor unit in an electromagnetic induction power generation device for electric vehicles according to a preferred embodiment of the present invention.

FIG. 5(b) illustrates a cross-sectional schematic diagram of a rotor unit in an electromagnetic induction power generation device for electric vehicles according to a preferred embodiment of the present invention.

FIG. 6(a)-(b) illustrate a three-phase coil configuration diagram of the stator unit in the electromagnetic induction power generation device for electric vehicles according to a preferred embodiment of the present invention.

FIG. 6(c) illustrates a schematic cross-sectional view showing the configuration of the stator unit and the rotor unit in the electromagnetic induction power generation device for electric vehicles according to a preferred embodiment of the present invention.

FIG. 6(d) illustrates the connection method of the stator unit with three-phase winding for electric vehicles according to a preferred embodiment of the present invention.

### DETAILED DESCRIPTION

Some preferred embodiments of the present invention will now be described in greater detail. However, it should be recognized that the preferred embodiments of the present invention are provided for illustration rather than limiting the present invention. In addition, the present invention can be practiced in a wide range of other embodiments besides those explicitly described, and the scope of the present invention is not expressly limited except as specified in the accompanying claims.

The “first”, “second”, etc. used herein do not specifically refer to order or sequence, nor are they used to limit the present invention. They are only used to distinguish between elements or operations described in the same technical terms.

Regarding the “connected” or “electrical coupled” used in this specification, it can mean that two or more components are directly physically connected or electrically contacted with each other, or indirectly physically connected or electrically contacted with each other, and ““connected” or “electrically coupled” can also refer to two or more components interoperating or acting.

To solve the issue of insufficient endurance of pure electric vehicles, a high-efficiency power converter assembly is required to convert the mechanical energy of the rotation of the vehicle's free-running wheels into sufficient auxiliary electric current. The present invention proposes a high-efficiency electromagnetic induction power generation device that can be integrated in an electric vehicle.

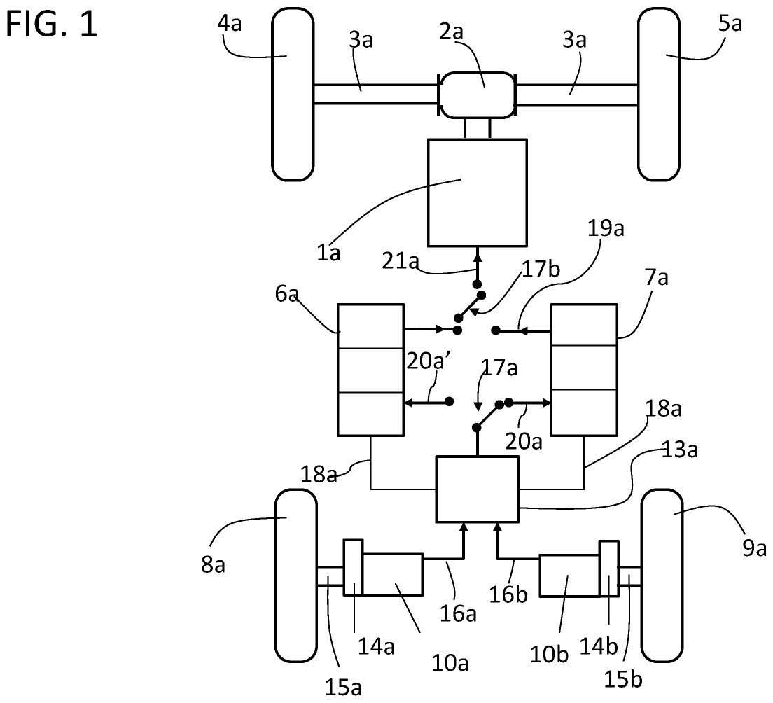

FIG. 1 shows a vehicle driven by electricity, which has a motor 1a for driving a pair of driving wheels (4a, 5a) of the vehicle through a differential gear device 2a and an axle 3a. The battery pack (6a, 7a) is used to provide power to the motor 1a alternately. The battery pack (6a, 7a) is charged alternatively by two power generating devices, the first power generating device 10a and the second power generating device 10b. The first power generating device 10a is rotated through free-running wheels 8a, axle 15a, and gearshift device (for example, gear box) 14a; The second power generating device 10b is rotated through free-running wheels 9a, axle 15b, and gearshift device (for example, gear box) 14b. In one embodiment, the gearshift device (14a, 14b) can be an variable ratio gearbox. The electric power generated by the first power generating device 10a can be supplied to the battery pack 6a through the wiring harnesses (16a, 20a′) and the switch 17a, and the electric energy generated by the second power generating device 10b can be supplied to the battery pack 7a through the wiring harnesses (16b, 20a) and the switch 17a, respectively. In one embodiment of the present invention, sensors (not shown) on the battery packs 6b and 7b signal the magnitude of stored electrical energy in each battery pack to the power distribution control center 13a through the wire harnesses 18a. The power of the motor can be adjusted to the proper rotation speed of the generator through the speed change devices (14a, 14b) located between the generator and the motor.

When the vehicle is in a balanced mode (that is, carrying a normal load on a level road without accelerating), the power generating devices (10a, 10b) are respectively combined with the gearboxes (14a, 14b) to provide a certain amount for the battery pack 7a, the motor 1a draws power from the battery pack 6a, the capacity of the power generating devices (10a, 10b) are set to provide a predetermined amount of energy to the battery pack 7a. As the speed of the vehicle speed decreases, electrical or mechanical signals are sent to the gearboxes (14a, 14b) through the controller (control center) 13a, which changes the gear ratio to increase the speed of the gearboxes (14a, 14b). The power generating devices (10a, 10b) maintain a predetermined electrical input to the battery pack 7a. The same is true when the battery pack 6a forms part of the battery charging circuit and the battery pack 7a forms part of the driving circuit.

The control center 13a switches between two power generating devices 10a and 10b to supply electrical power to the appropriate battery pack 6a or 7a. The control center 13a also adjusts the ratio of one or both of the gearboxes 14a and 14b and engages or disengages them when needed. As the battery pack 7a is used in the power drive circuit and the battery pack 6a is used in the charging circuit, the non-power battery pack 7a provides sufficient power to charge the battery for subsequently driving the vehicle. When the sensor (not shown) on the battery pack 6a supplying power indicates that its power has been reduced to a preset value, the distribution control center 13a reverses the switches 17b and 17b from the their current positions so that the fully charged battery pack 7a can supply electric power to the motor 1a through the wiring harnesses 19a and 21a and the switch 17b, and these wiring harnesses are part of an electric drive circuit for driving the vehicle. At the same time, the battery pack 6a enters the charging mode from the power generating devices (10a, 10b) via the control center 13a, the switch 17a and the wiring harness 20a′. In one preferred embodiment, the two power generating devices 10a and 10b may have exactly the same structure.

In order to convert the mechanical energy of the free-running wheels of the vehicle into sufficient auxiliary electrical current, a power generating device with high conversion efficiency is the key point among them. It can be mechanically coupled to a free-running wheels of the vehicle through the rotation shaft of the power generating device rotatably coupled to a transmission device connected to the free-running wheels, such as a gearbox set or the like, to convert the rotating mechanical energy of the free-running wheels into electrical energy, and the electric energy generated by the power generating device is stored in the battery pack installed on the electric vehicle through the charging circuit.

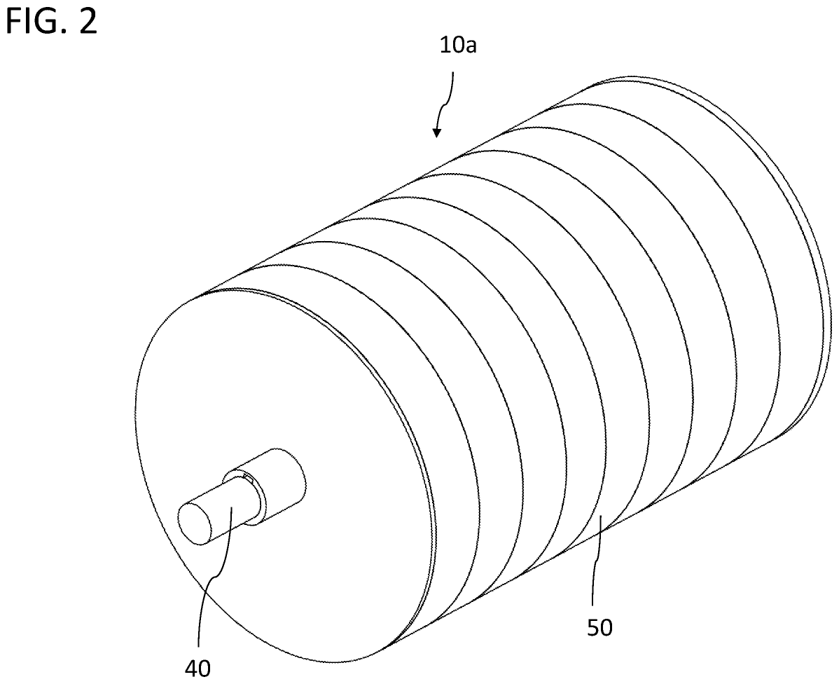

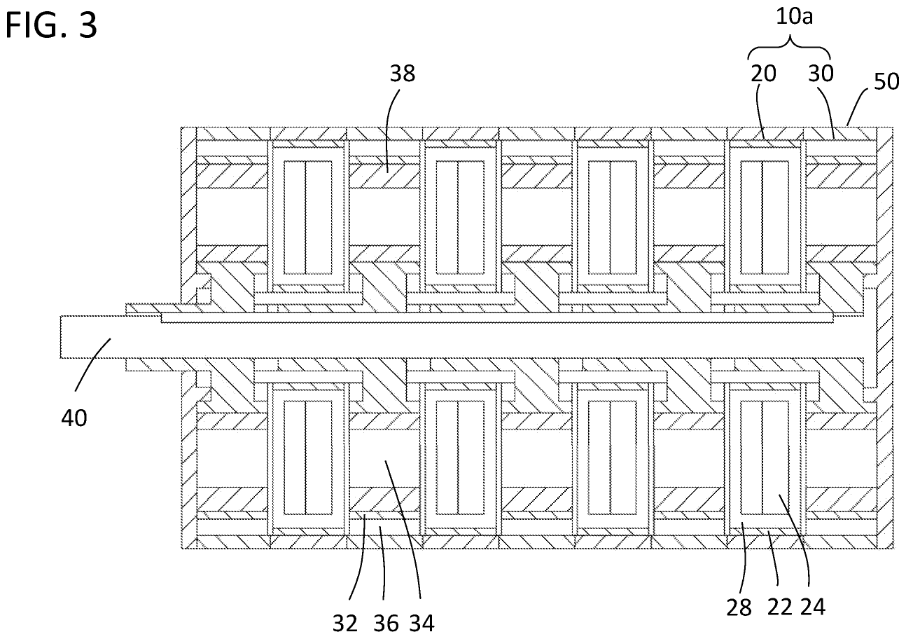

Please refer to FIG. 2 and FIG. 3, which disclose an electromagnetic induction device 10a (generator) for generating electricity or electric power. Power generator consists a plurality of coaxially assembled electromagnetic induction device 10a installed inside a cylindrical shell 50, the electromagnetic induction device 10a includes a stator assembly containing a plurality of stator units 20 and a rotor assembly containing a plurality of rotor units 30. The plurality of stator units 20 are axially and equidistantly fixed in the housing 50 as a stator, and the plurality of rotor units 30 are coupled by a rotation shaft 40 to rotate coherently. Inside the electromagnetic induction device 10a, each rotor unit 30 is installed between two adjacent stator units 20.

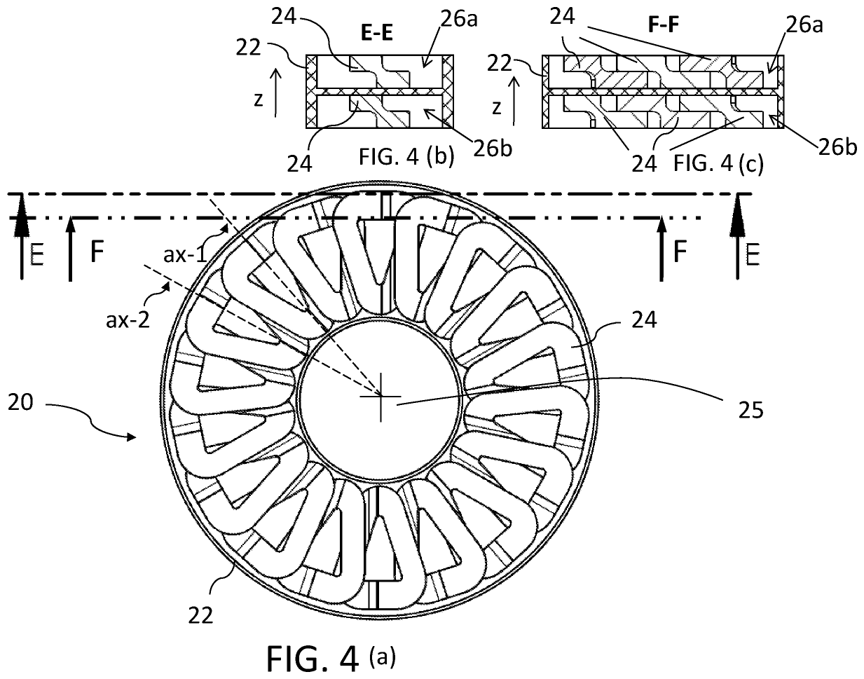

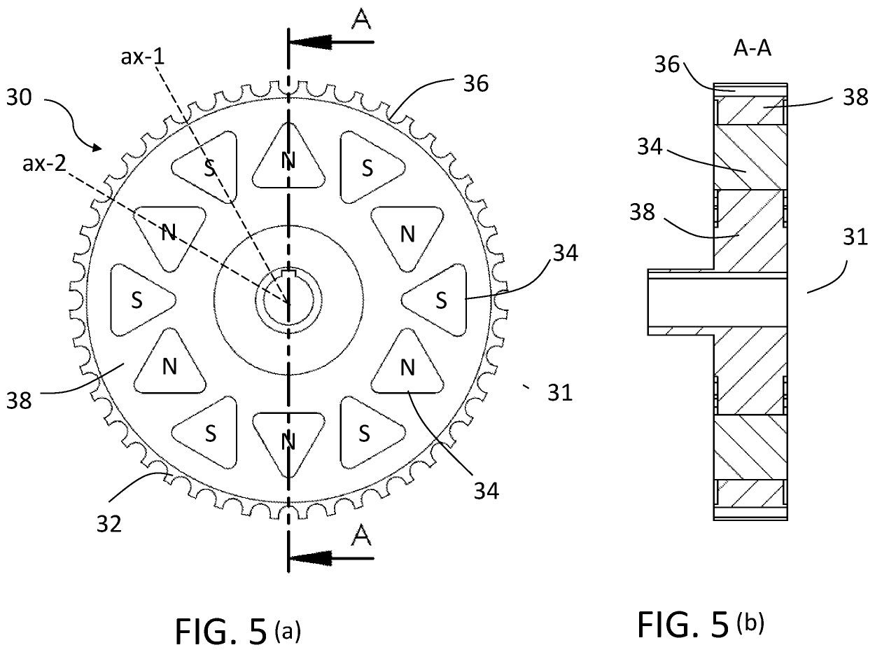

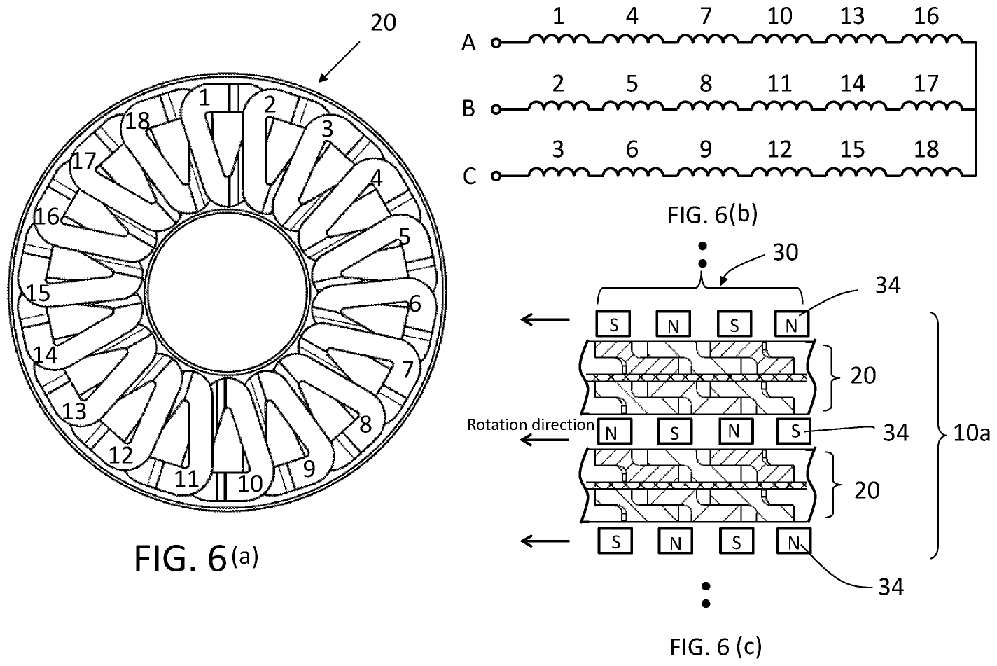

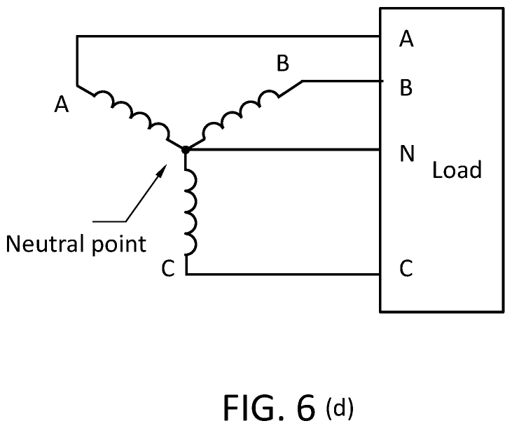

FIG. 4(a) shows a front view of the stator unit 20, which includes a non-magnetic stator base (coil base) 22 and a plurality of coils 24 azimuthally arranged in a coil base 22 with equal radial angles. In one embodiment, the number of the coils 24 is ranged from 12-72, preferably, 18-36. Each of the coils 24 is wound by enamel-insulated copper wire (conducting wire) and forms a looped coil structure with a bended Z-shaped cross-section as shown in FIG. 4(b) (which is a cross-sectional view along E-E cutting direction) and FIG. 4(c) (which is a cross-sectional view along F-F cutting direction). In this manner, please refer to FIG. 4(a)-4(c), each of the coils 24 forms bended cross section, which can be partially stacked on top of each other side by side with compact packing capability, where the coils 24 can be arranged to have their individual vertical bisector aligned with a set of radial axes (ax-1, ax-2, . . . ) of the stator base. The overlap area between adjacency coils is around 30-50 percent surface area of the coils. In one of the preferred embodiments, the number of windings of each coil is 100-140 turns, preferably, 120 turns. In one of the preferred embodiments, the stator base 22 is a cylinder shape having a center hole 25 for passing the rotation shaft 40 through and a space formed between a circular inner wall and a circular outer wall for accommodating coils 24 within, the space is equally partitioned into two subsections along the axial direction (z direction) with a partition wall in between. Coils installed inside both subsection of the stator base 22 can interact with permanent magnets of rotor unit (please refer to FIG. 2, FIG. 5, and FIG. 6) installed on both sides of the stator base 22. In one of the preferred embodiment, each of the coils 24 is wrapped with enamel-insulated conducting wire to form an isosceles triangular like shape (or similar shape, such as trapezoid shape) and then bended along its vertical bisector to form a “Z” shape cross section. Each of the isosceles triangular shape (or trapezoid shape) coils 24 is arranged with its base facing the circular outer wall of the stator base 22. Once these coils 24 have installed in their correct positions, a filler material 28, such as epoxy resin mixer, is filled with the space (26a, 26b) for securing coils in place and improving coil's insulating and thermal properties.

FIG. 5(a) illustrates a front view of an individual rotor unit 30, which includes a disk like (cylindered) non-magnetic rotor base 32 having a plurality of permanent magnets 34 (which can be NdFeB permanent magnets) installed, a central hole 31 for coupling a rotation shaft 40, and a plurality of slots 36 arranged at outer edge of the magnetic base for reducing weight and enhancing heat dissipation. These permanent magnets 34 are azimuthally arranged with equal radical angle distribution within the non-magnetic rotor base 32 and magnetic poles of neighboring magnets have opposite magnetic polarity, i.e. N polarity versus S polarity, arranged alternatively. FIG. 5(b) shows a cross-sectional view of an individual rotor unit 30 along A-A cutting direction. Once these permanent magnets 34 have installed in their correct positions, a filler material 38, such as epoxy resin mixer, is filled with the rest space for securing these permanent magnets in place. In one of the preferred embodiments, each of the permanent magnets 34 is a columnar with equilateral triangular cross section, where the permanent magnets 34 can be arranged to have their individual vertical bisector aligned with a set of radial axes (ax-1, ax-2, . . . ) of the magnet base 32 with equal radical angle distribution and the base of the permanent magnets 34 with a first type of the magnetic polarity (for example N polarity) can be configured to face toward the center of the magnet base 32 while the base of the permanent magnets 34 with a second type of the magnetic polarity (for example S polarity) can be configured to face toward the outer edge of the magnet base 32. In one of the preferred embodiments, each permanent magnet can produce a magnetic field of 3000-7000 Gauss, preferably, 5000 Gauss.

FIGS. 6(a)-6(b) show an exemplary winding configuration of one set of the stator unit 20, a connection of three-phase windings A, B, and C is illustrated in FIG. 6(b), where the marked numbers in FIG. 6(a) represent individual coil of the stator unit 20. Among them, the coils 1, 4, 7, . . . are connected in series along the circumference; the coils 2, 5, 8, . . . are connected in series; the coils 3, 6, 9, . . . are connected in series.

FIG. 6(c) illustrates a cross-sectional view of configuration between stator units 20 and rotor units 30 of the magnetic induction device 10a. From FIG. 6(c), it is clear that the compact packing stator units 20 together with the columnar permanent magnets 34 with equilateral triangular cross section installed in the rotor units 30 can provide a highly efficient magnetic induction unit without any lamented steel sheets needed for coil winding.

FIG. 6(d) illustrates connection of the rotor unit 20 having three-phase windings A, B, and C, where the AC power generated from the magnetic induction device 10a can be fed into the load for electric application.

While various embodiments of the present invention have been described above, it should be understood that they have been presented by a way of example and not limitation. Numerous modifications and variations within the scope of the invention are possible. The present invention should only be defined in accordance with the following claims and their equivalents.

What is claimed is:

1. An electric vehicle with magnetic induction power generating device comprising:
a vehicle body;
at least one battery pack installed inside the vehicle body;
at least one power generating device electrically coupled to the at least one battery pack for providing electricity;
a transmission device coupled to the power generating device; and
at least one motor powered by the at least one battery pack for driving the electric vehicle, wherein the at least one power generating device is coupled to at least one free-running wheel of the electric vehicle through the transmission device for converting a rotating energy of the at least one free-running wheel into electricity.

2. The electric vehicle with magnetic induction power generating device of claim 1, wherein the at least one power generating device includes:
a cylindrical shell;
a stator assembly having a plurality stator units axially and equal spaced fixed inside the cylindrical shell, each stator unit including a stator base and a plurality of coils azimuthally arranged within the stator base with equal radical angle distribution; and
a rotor assembly having a plurality of rotor units, each rotor unit including a rotor base and a plurality of permanent magnets azimuthally arranged inside the rotor base with equal radical angle distribution, wherein the plurality of rotor units are connected by a rotation shaft for rotating coherently and each rotor unit is arranged in between neighboring stator units.

3. The electric vehicle with magnetic induction power generating device of claim 2, wherein the stator base is a cylindered shape having a center hole for passing the rotation shaft.

4. The electric vehicle with magnetic induction power generating device of claim 2, wherein the stator base has a space formed between a circular inner wall and a circular outer wall for accommodating the coils.

5. The electric vehicle with magnetic induction power generating device of claim 4, wherein the space formed between the circular inner wall and the circular outer wall of the stator base is equally partitioned into two subsections along its axial direction.

6. The electric vehicle with magnetic induction power generating device of claim 5, wherein the coils installed inside both of the subsections of the stator base.

7. The electric vehicle with magnetic induction power generating device of claim 2, wherein each of the coils is winded by enamel-insulated conducting wire and forms a loop structure with bended “Z” shape cross section.

8. The electric vehicle with magnetic induction power generating device of claim 7, wherein each of the coils is partially stacked on top of each other side by side for forming compact packing.

9. The electric vehicle with magnetic induction power generating device of claim 2, wherein the stator base is non-magnetic.

10. The electric vehicle with magnetic induction power generating device of claim 2, wherein the rotor unit includes a non-magnetic cylindered rotor base having a center hole for coupling the rotation shaft.

11. The electric vehicle with magnetic induction power generating device of claim 2, wherein magnetic poles of neighboring permanent magnets have opposite magnetic polarity arranged alternatively.

12. The electric vehicle with magnetic induction power generating device of claim 11, wherein each of the permanent magnets is a columnar with equilateral triangular cross section and the permanent magnets are arranged to have their individual bisector aligned with a set of radical axes of the rotor base with equal radical angle distribution.

13. The electric vehicle with magnetic induction power generating device of claim 12, wherein base of the permanent magnets with a first type of the magnetic polarity are configured to face toward center of the rotor base while the base of permanent magnets with a second type of the magnetic polarity are configured to face toward outer edge of the rotor base.

14. The electric vehicle with magnetic induction power generating device of claim 12, wherein the first type the magnetic polarity is N polarity.

15. The electric vehicle with magnetic induction power generating device of claim 12, wherein the second type the magnetic polarity is S polarity.

16. The electric vehicle with magnetic induction power generating device of claim 2, wherein each of the permanent magnets is a NdFeB magnet.
